(19) United States
(12) Patent Application Publication
(10) Pub. No.: US 2024/0081961 A1
(43) Pub. Date: Mar. 14, 2024

(54) METHOD OF PRODUCING A DENTAL RESTORATION

(71) Applicant: Ivoclar Vivadent AG, Schaan (LI)

(72) Inventors: Sebastian Gassner, Triesenberg (LI); Nina Mathis, Ruggell (LI); Louis Tiefenthaler, Triesenberg (LI); Fabian Schmid, Braz (AT)

(21) Appl. No.: 18/464,209

(22) Filed: Sep. 9, 2023

(30) Foreign Application Priority Data
Sep. 9, 2022 (EP) 22194872.2

(51) Int. Cl. A61C 13/00; A61C 13/083

(52) U.S. Cl. CPC A61C 13/0006; A61C 13/0022; A61C 13/083

(57) ABSTRACT

A method of producing a dental restoration, including the steps of producing (S101) the dental restoration in an initial geometry having an excess volume compared to the final geometry to be produced; infiltrating (S102) the initial geometry with an investment material; and removing (S103) the excess volume with the investment material to produce the final geometry.

### CROSS-REFERENCE TO RELATED APPLICATIONS

This application claims priority to European Patent Application No. 22194872.2 filed on Sep. 9, 2022, the disclosure of which is incorporated herein by reference in its entirety.

### TECHNICAL FIELD

The present invention relates to a method of producing a dental restoration and a production device for producing a dental restoration.

### BACKGROUND

Dental restorations can be milled out of a blank. After the end of the milling process, they remain connected to the blank via retaining bars. A reduction of the retaining bars leads to an unstable connection to the blank. Manual reworking to remove the dental restoration from the blank requires time and skill. Furthermore, the problem arises that manual reworking of the dental restoration can change its geometry unintentionally. Manual cementation of the dental restoration using melted wax is also time-consuming and labor-intensive. Surface finishing is also time-consuming, and in manual processes, the result depends on the skill of the user. In addition, design guidelines restrict the user in the design of the dental restoration and adapted machining parameters only partially achieve the goal.

Cleaning with a brush is labor-intensive on the one hand. On the other hand, it is difficult to assess whether the cleaning effect is high enough. However, dust residues, which are easier to remove before sintering, often only become visible after sintering. Wet processing of the dental restoration leads to problems with contamination of the material and makes a drying phase necessary before the sintering process.

### SUMMARY

It is the technical object of the invention to simplify the production of a dental restoration.

This technical object is solved by subject matter according to the independent claims. Technically advantageous embodiments are the subject matter of the dependent claims, the description and the drawings.

According to a first aspect, the technical object is solved by a method of producing a dental restoration, comprising the steps of producing the dental restoration in an initial geometry having an excess volume compared to the final geometry to be produced; infiltrating the initial geometry with an investment material; and removing the excess volume with the investment material to produce the final geometry. The initial geometry may have the excess volume partially or completely compared to the final geometry to be produced. The excess volume and/or the investment material may be partially or completely removed to create the final geometry. After milling the dental restoration, there is no need to manually separate any connected retaining bars on a blank. The milled surfaces of the dental restoration have a smooth structure that does not require manual finishing and polishing. Filigree structures, such as veneers and inlays, can be produced with the method, even though there is an increased risk of chipping with brittle materials due to material, tool and process properties. The accumulation of dust residues in the pores and on the surface can be prevented, which in a subsequent sintering process would lead to problems and a high cleaning or reworking effort. In addition, manual rework is reduced.

The method prevents dust residues from forming, especially in the fissures, which are difficult to polish or clean manually.

In a technically advantageous embodiment of the method, the investment material is cured. Curing can be carried out by means of light or thermally. This achieves the technical advantage, for example, that the machinability is improved.

In a further technically advantageous embodiment of the method, milling residues are sucked off, brushed or blown off during the production of a final geometry and/or removal of the excess volume. This achieves the technical advantage, for example, that milling residues do not cause any problems during sintering.

In a further technically advantageous embodiment of the method, the excess volume is formed by a layer having a uniform thickness. This achieves the technical advantage, for example, that the excess volume can be removed in a simple manner.

In a further technically advantageous embodiment of the method, the initial geometry is produced from a blank by printing or milling and/or the excess volume is produced using a subtractive process. This achieves the technical advantage, for example, that the initial geometry can be produced efficiently.

In a further technically advantageous embodiment of the method, the blank is formed from zirconium dioxide, polymethyl methacrylate, lithium disilicate or cobalt chromium. This achieves the technical advantage, for example, that particularly suitable materials are used.

In a further technically advantageous embodiment of the method, the investment material is filled into a milled gap between the initial geometry and the blank. This achieves the technical advantage, for example, that the investment material can be distributed in the gap.

In a further technically advantageous embodiment of the method, first a portion of the initial geometry is produced which is infiltrated with the investment material and then another portion of the initial geometry is produced which is infiltrated with the investment material. This achieves the technical advantage, for example, that the dental restoration can be retained in the blank.

In a further technically advantageous embodiment of the method, the investment material is formed by a polymer, such as polyethylene glycol, a light-cured polymer, a wax or a surfactant. This achieves the technical advantage, for example, that particularly suitable investment media are used.

In a further technically advantageous embodiment of the method, the investment material is removed by heating the dental restoration. This achieves the technical advantage, for example, that the investment material can be easily removed without leaving any residue.

According to a second aspect, the technical object is solved by a production device for producing a dental restoration, comprising a shaping device for producing the dental restoration in an initial geometry having an excess volume compared to the final geometry to be produced; an infiltration device for infiltrating the initial geometry with an investment material; and a removal device for removing the excess volume with the investment material to produce the final geometry. Thereby, the same technical advantages are achieved as by the method according to the first aspect.

In a technically advantageous embodiment of the production device, the production device comprises a curing device for curing the investment material. This achieves the technical advantage, for example, that the surface of the dental restoration can be improved. In this case, only part of the infiltrated layer can be partially cured, such as curing in the upper depth. If the investment material is cured at least to above the end of the excess volume, the desired effect is created at the milling edge.

In a further technically advantageous embodiment of the production device, the curing device comprises a light source for curing the investment material. This achieves the technical advantage, for example, that the investment material can be cured in a simple manner.

In a further technically advantageous embodiment of the production device, the production device comprises a heating device for removing the investment material. This achieves the technical advantage, for example, that the investment material can be efficiently removed.

In a further technically advantageous embodiment of the production device, the shaping device comprises a milling device. This achieves the technical advantage, for example, that the dental restoration can be produced in a simple manner.

### BRIEF DESCRIPTION OF THE DRAWINGS

Exemplary embodiments of the invention are shown in the drawings and are described in more detail below, in which:

FIG. 1 shows a block diagram of a method of producing a dental restoration; and

FIG. 2 shows a schematic representation of a production device for producing the dental restoration; and

FIG. 3 shows a perspective view of a ring around an equator of the dental restoration and retaining bars of the dental restoration.

### DETAILED DESCRIPTION

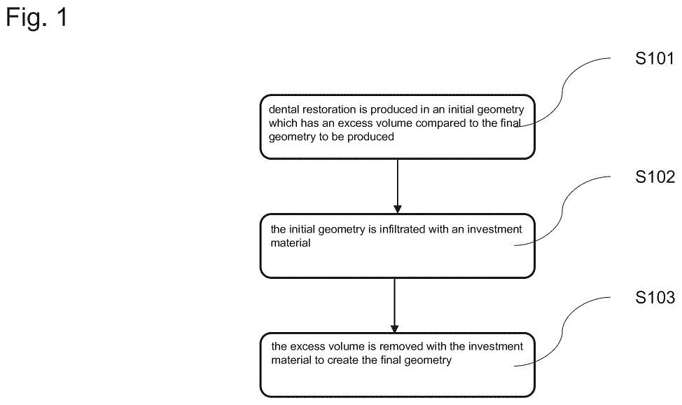

FIG. 1 shows a block diagram of a method of producing a dental restoration. In step S101, the dental restoration is produced in an initial geometry which has an excess volume compared to the final geometry to be produced. Then, in step S102, the initial geometry is infiltrated with an investment material. Subsequently, in step S103, the excess volume is removed with the investment material to create the final geometry.

For example, to improve the surface quality when machining porous zirconium dioxide, the initial geometry is first produced with an excess volume and then infiltrated with an investment material. The excess volume depends on how deeply the investment material penetrates the pores. The minimum excess volume corresponds to a layer thickness of 0.02 mm to 0.2 mm, preferably 0.05 mm (finishing process), or 0.1 or 0.08 mm to 2 mm (roughing process), although other values are also conceivable.

A finishing or roughing process may then be sufficient to remove the excess volume. After the surfaces to be machined have been pre-machined with an excess volume and infiltrated with the investment material and cured, the polymer and residual material are removed to form the final geometry. On the one hand, this allows a glossy surface to be milled and, on the other hand, the milling dust, which consists of a mixture of zirconium dioxide and polymer, can be removed more easily.

The residues of the investment material which are not separated from the dental restoration can then be burned in the heating phase of a sintering process at advantageously 580° C. to 600° C. in a heating device 121. From the clamping of the blank to the loading of the sintering furnace, a fully automatic machining process can be carried out without interruption or interaction with the user.

The infiltration or investment material is initially flowable or viscous for infiltration of the dental restoration and then solid for the milling process. For example, the investment material comprises an organic compound. The one organic compound comprises:
a) a polymerizable monomer and/or a mixture of polymerizable monomers comprising liquid polymerizable monomers, and/or
b) polymers, in particular polymers of the abovementioned monomers, and/or
c) wax, in particular a liquefiable wax, in particular an undecomposed liquefiable wax or surfactants or polyethylene glycol. Suitable waxes are, for example, adhesive waxes, milling waxes and universal waxes, such as in particular paraffin-containing waxes, dental waxes, in particular paraffin, ceresin, carnauba wax, cocoa butter, beeswax, stearic acid and/or microcrystalline, paraffinic hydrocarbon waxes.

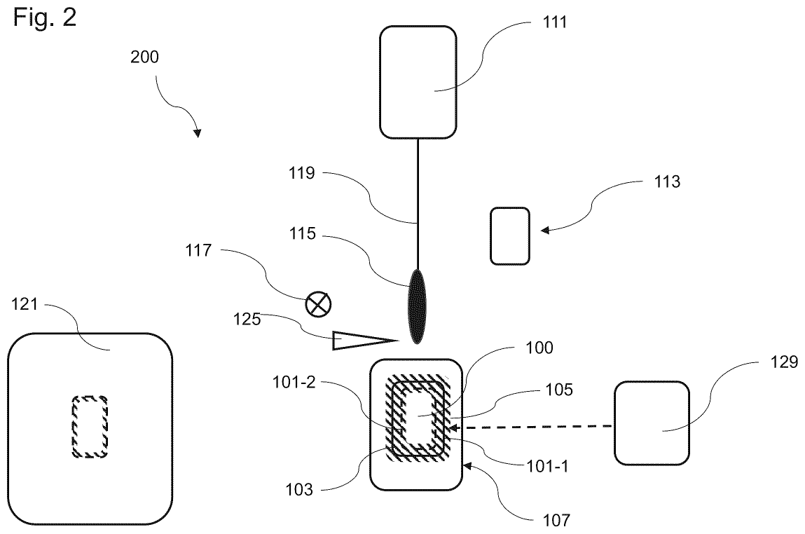

FIG. 2 shows a schematic representation of a production device 200 for producing the dental restoration 100. The production device 200 comprises a shaping device 111 for producing the dental restoration 100 in an initial geometry 101-1, which has an excess volume 103 compared to the final geometry 101-2 to be produced. The shaping device is formed, for example, by a milling device having a milling tool 119.

The production device 200 additionally comprises an infiltration device 113 for infiltrating the initial geometry 101-1 with an investment material 105. In the investing process, for example, a light-curing monomer is used as the investment material 105. This is stored in a tank 129 at the production device 200 and delivered to the blank 107 via a squeeze pump.

After the monomer is introduced into the blank 107, a light source 117 with UV light is activated as a curing device and the curing process is started. This can be carried out in several cycles. In this process, the light source 117 is located in a milling chamber and has light contact with the blank 107.

For example, the milling tool 119 serves as a removal device 115 for removing the excess volume 103 with the investment material 105 to create the final geometry 101-2. An air jet can also be directed onto the tool tip via a nozzle 125. This allows the resulting milling dust to dissipate before it can be deposited on the dental restoration 100. This effect can be intensified with a pulsating jet of compressed air.

In addition, the dental restoration 100 can be produced without retaining bars so that manual reworking is eliminated.

In this case, the dental restoration 100 is first produced on one side above the equator with an excess volume. The removed material is refilled with a light-curing monomer as investment material 105 and cured.

Machining can then continue on the side below the equator. After this side has also been finished, most of the previously introduced investment material 105 is removed again so that the dental restoration 100 can be held on one or more retaining bars consisting of the investment material 105.

A thin ring is also a suitable alternative to the retaining bars. To enable automated individual dispensing from the production device 200, the retaining bars can be separated from the blank 107 so that the dental restoration 100 falls in free fall into a dispensing mechanism or is removed by means of a gripper.

The area to be filled with an investment material 105 is variable. However, the dental restoration 100 should have sufficient stability when the tool 119 pierces it and should be protected from falling out or being separated. Areas around the equator are filled with sufficient investment material 105 for this purpose. The filling height measured from the equator corresponds at least to the tool radius. The filling height measured from the milling path, which is usually below the equator, corresponds at least to the tool diameter. In this case, even when the tool 119 pierces, there is sufficient investment material 105 to form retaining bars or other support geometries, such as a disk.

Since the wax residues are only removed during sintering, the surfaces covered by wax cannot be cleaned with a brush. Wax residues in the cavity or in the fissures should therefore be avoided or removed together with the excess volume.

Advantageously, the cavity or the occlusion is milled only after the investment process. After that, these surfaces are freely accessible after machine production and can be cleaned with a brush or otherwise.

Dust formation can also be minimized by means of the investment material at the areas where no excess volume is provided. In this case, the areas of the existing final geometry should be sucked off, brushed or blown off during the production process. If these areas are also infiltrated or the investment medium is applied, it is advantageous if the investment medium at areas of the final geometry is removed together with the excess volume in the machine.

The amount of investment material 105 required and the investment position can be determined via the CAM software. The investment material 105 is a viscous monomer which is converted into a solid polymer by exposure to light. The polymer can be completely removed in the sintering furnace. Alternative materials are waxes or surfactants. These are liquid or viscous when heated and solid when cooled.

The production device 200 may further comprise a heating device 121 for removing the investment material 105 or sintering the dental restoration 100. Residue-free firing of the investment material 105 is technically advantageous. Alternatively, (water-) soluble materials may be used which can be washed off the restoration prior to the firing process. In the solid state, the investment material should have similar milling properties as the dental blank 107.

For example, if the blank 107 is formed of porous zirconium dioxide, the milling forces will not be too high when machining the investment material 105 so that zirconium dioxide cannot be damaged. If the blank 107 is formed of solid material, such as cobalt chromium or lithium disilicate, it is advantageous if the investment material 105 can withstand the high milling forces and allows similar machining parameters as the material of the blank 107.

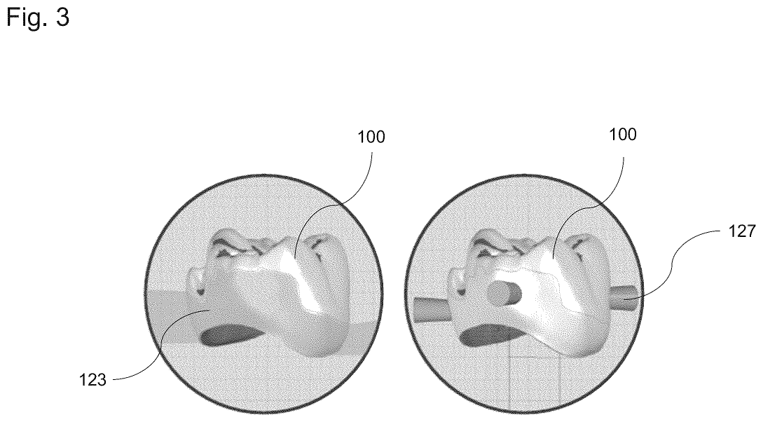

FIG. 3 shows a perspective view of a ring 123 around an equator of the dental restoration 100 and retaining bars 127 of the dental restoration 100.

The retaining bars 127 are not only positioned on the equator as in a conventional milling process, but can also be positioned on one side of the equator, namely on the side where the investment material is located. Alternative geometries to a classic retaining bar 127 are also possible. For example, the dental restoration 100 can be held to the blank 107 with the thin ring 123 along, above or below the equator.

Since no retaining bars have to be positioned, the milling paths do not have to avoid the retaining bar. Abrupt accelerations and decelerations along the axial axis of the tool can thus be avoided.

All of the features explained and shown in connection with individual embodiments of the invention may be provided in different combinations in the subject matter of the invention to simultaneously realize their beneficial effects.

All method steps can be implemented by devices which are suitable for executing the respective method step. All functions that are executed by the features of the subject matter can be a method step of a method.

The scope of protection of the present invention is given by the claims and is not limited by the features explained in the description or shown in the figures.

### REFERENCE LIST

100 Dental restoration
101-1 Initial geometry
101-2 Final geometry
103 Excess volume
105 Investment material
107 Blank
111 Shaping device
113 Infiltration device
115 Removal device
117 Curing device
119 Milling tool/tool
121 Heating device
123 Ring
125 Nozzle
127 Retaining bar
129 Tank

What is claimed is:

1. A method of producing a dental restoration (100), comprising the steps of:
producing the dental restoration in an initial geometry, which has an excess volume compared to the final geometry to be produced;
infiltrating the initial geometry with an investment material; and
removing the excess volume with the investment material to create the final geometry.

2. The method according to claim 1, wherein the investment material is cured.

3. The method according to claim 1, wherein milling residues are sucked off, brushed or blown off when producing the final geometry or when removing the excess volume.

4. The method according to claim 1, wherein the excess volume is formed by a layer having a uniform thickness.

5. The method according to claim 1, wherein the initial geometry is produced from a blank by printing or milling and/or the excess volume is produced by a subtractive process.

6. The method according to claim 5, wherein the blank is formed from zirconium dioxide, polymethyl methacrylate, lithium disilicate, or cobalt chromium.

7. The method according to claim 5, wherein the investment material is filled into a milled gap between the initial geometry and the blank.

8. The method according to claim 1, wherein a portion of the initial geometry is first produced that is infiltrated with the investment material, and then another portion of the initial geometry is produced that is infiltrated with the investment material.

9. The method according to claim 1, wherein the investment material is formed by a polymer, a light-cured polymer, a wax or a surfactant.

10. The method according to claim 1, wherein the investment material is removed by heating the dental restoration.

11. A production device for producing a dental restoration, comprising:
a shaping device for producing the dental restoration in an initial geometry which has an excess volume compared to the final geometry to be produced;
an infiltration device for infiltrating the initial geometry with an investment material; and
a removal device for removing the excess volume with the investment material to create the final geometry.

12. The production device according to claim 11, wherein the production device comprises a curing device for curing the investment material.

13. The production device according to claim 12, wherein the curing device comprises a light source for curing the investment material.

14. The production device according to claim 11, wherein the production device comprises a heating device for removing the investment material.

15. The production device according to claim 11, wherein the shaping device comprises a milling device.
